(19) United States
(12) Patent Application Publication
(10) Pub. No.: US 2021/0209885 A1
(43) Pub. Date: Jul. 8, 2021

(54) A SYSTEM AND A METHOD FOR ACHIEVING CONSENSUS BETWEEN MULTIPLE PARTIES ON AN EVENT

(71) Applicant: CENTIGLOBE AB, Sollentuna (SE)

(72) Inventors: Filip LUNDIN, Stockholm (SE); Simon NORELL, Stockholm (SE); Sigge AHLQVIST, Bromma (SE); Daniel FREDÉN, Uppsala (SE); Hampus LARSSON, Stockholm (SE); Ivar BENGTSSON, Enskede (SE); Michael FICHTER, Stockholm (SE); Lukas GRANNAS, Stockholm (SE); Henrik GRADIN, Sollentuna (SE); Felix MIR, Stockholm (SE); Fredrik RAHM, Stockholm (SE)

(21) Appl. No.: 17/057,183

(22) PCT Filed: May 17, 2019
(86) PCT No.: PCT/SE2019/050450

§ 371 Date: Nov. 20, 2020

(30) Foreign Application Priority Data
May 23, 2018 (SE) 1850613-9

(51) Int. Cl. G07C 13/00; H04L 9/32

(52) U.S. Cl. CPC G07C 13/00; H04L 2209/56; H04L 9/3239

(57) ABSTRACT

The present invention relates to a system and a method for achieving consensus between multiple parties (A, B, C) on an event and/or order of events (1 . . . 5) at high speed by verifying and voting on events by creating a voting event referencing one or multiple other events individually or as a group of events.

### FIELD OF INVENTION

The present invention relates to a system and a method for achieving consensus between multiple parties on an event and/or order of events at high speed.

### BACKGROUND

Bitcoin [1] was the first cryptocurrency to gain traction and to show the potential use of blockchain and distributed ledger technologies. It is still the largest cryptocurrency on the market, even though it continuously battles with some serious limitations. A few disadvantages of the Bitcoin network are slow transaction speeds, high volatility and high power consumption. The fee for making a transaction on the network can be as high as $50, and it can take hours to complete [2, 3, 12]. While waiting for validation, the price of a bitcoin relative to the dollar can have changed so much that the value of the completed transaction does not cover the price of the product bought [2]. Price drops of 25% within a few days has occurred [2]. Because of these price fluctuations, one of the largest online retailers of computer games, Steam, has removed the possibility of using bitcoins as payment [2]. With a currency you would expect your income to cover your expected expenses, but the aforementioned problems show why Bitcoin can be seen more like a speculative asset rather than a currency [4].

Other platforms seeking to address the volatility of cryptocurrencies are Tether and Bitshares [10]. Tether keeps a peg to the dollar with a claim of having a reserve of dollars equal to the number of coins in circulation. However, in a possible “bank run”, the outcome is not clear since the single guarantee might not have all the funds in its reserve as have been promised [24]. Bitshares has solved this by having two different assets: BitUSD and BitShares. The market speculates on the two assets which makes it possible to keep BitUSD at the same price as the dollar. However, the negative aspect is that their solution is based on a centralized model, since the bitShare company is the last resort, guaranteeing the peg. BaseCoin tries to address this problem. The idea of BaseCoin is that any asset can be pegged to the coin without a centralized company backing it [10]. It uses the Quantity Theory of Money, where the money supply is changed to keep the currency price relatively fixed. However, this currency is still dependent on an oracle that externally checks on markets for current exchange rates.

The main drawback of these currencies which are controlled by market speculation is that they only work as long as the currency has buyers. When the currency has lost trust the peg will not be able to hold and the currency collapses as most fixed currency projects has done in the financial history [17].

To solve this fundamental problem, MakerDao has created the stable currency DAI which is pegged to the dollar and always backed by other assets, referred to as collateral [18]. To keep the peg, DAI has similar economic incentives as other stable currencies. However, to avoid the currency collapsing its creation starts with collateral that is worth 150% of the currency value. In case the underlying collateral becomes less valuable than for example 125%, the underlying assets is auctioned out automatically, effectively securing the value of the coin. This has the drawback that there is always more value stored in the currency than can be used, effectively locking up capital. In addition a sudden drop in the value of the underlying asset will force it to be sold on the market, effectively collapsing the underlying asset in case too much of it is locked up in DAI. In summary, these kill switches that DAI has added to protect itself adds risks to the users that converts to DAI.

A disadvantage of many cryptocurrencies and the distributed ledger technology they are running on is the high power consumption. The total power consumption of the Bitcoin network recently surpassed the power consumption of Ireland [5]. This is a huge problem from an environmental perspective, and it needs to be addressed. In Bitcoin, securing the network and confirming transactions is done by Proof of Work (PoW), where a random nonce is to be found for every block in the chain. This work is referred to as mining, where a successful miner is rewarded with new coins. The block reward has a semi-fixed discovery rate of around one block every 10 minutes. This implies that the marginal cost of mining will always approach the marginal revenue of the reward. When the price of a bitcoin increases, the marginal revenue will also increase. Thus, it is affordable to invest more equipment and power into the discovery of new blocks. As long as demand for Bitcoins is higher than the discovery rate of new coins, the price will go up, and it is affordable to put more power into the network for block discovery and mining.

An alternate way of securing a cryptocurrency is by voting schemes or so called Proof of Stake (PoS), where validators secure the blockchain relative to how many coins they hold, instead of how much computing power they consume. Consensus in these blockchains can be achieved by for example specific number of voting rounds for a selected amount of nodes [13], time limited voting rounds relative to stake [9] or longest chain [21, 23] with addition of strengthening the chain in a heaviest or widest chain voting fashion [7, 25]. The disadvantages of most of these algorithms are that nothing is at stake, i.e. there is no personal risk for a validator to validate an incorrect transaction [16]. It is usually claimed that holding the network trustworthy and valid is in everyone's interest [9]. However, validating transactions takes computer resources, and thus it's optimal to let someone else validate a transaction and hope that they still want to keep the network secure. In addition the people with the highest stakes control the network. In practice, this means that only networks of a closed trusted community with an economic gain can use this type of system, such as Ripple [13]. An alternate way is to have a Delegated Proof of Stake model, where every user delegates their stakes voting power to running validators [21, 23]. This has the benefit that all users with a low stake are also able to contribute to the networks security equally. However, most implementations at the moment has the disadvantage that a node can go rogue instantly but it takes a while for the delegated stake to move to other more trustworthy nodes. Many solutions also implement voting rounds, e.g. EOS [23], where one validator is assigned a time to generate a new block. However, this makes the network susceptible to denial of service attacks, since only one node at a time needs to be attacked to stop the networks block generation.

An alternate way to solve the nothing at stake problem and vulnerability of PoS systems has been proposed by the developers in the Ethereum community. In this new PoS algorithm, everyone that is validating transactions receive rewards and bet their stake on which transactions are valid. This gives incentives for each individual to act according to the likely consensus to be able to claim the rewards and not to lose their bet [7]. However, the Casper algorithm has the disadvantage of it being complex to choose how the rewards and penalties should be distributed in a way to reduce the risks of forks and the uncertainty of which fork will be the correct one in the future.

Another benefit of PoS algorithms is that they are significantly faster at validating transactions compared to PoW algorithms since no heavy computations needs to be performed. However, to approve hundreds of thousands of transactions a second, as current state-of-the-art centralized systems do [14], a ledger consisting of one central blockchain is not enough since the amount of data transferred between nodes is vast and every node needs to keep a copy of this central ledger.

To achieve complete decentralization, the ledger needs to be distributed over the nodes in a way that nodes can process transaction confirmations at different times. One such solution is sharding; where blocks with transactions in the blockchain are divided and can be processed in parallel. Some investigation and trials have been done in this area most notably by the Ethereum organization [6]. One example of a cryptocurrency under development that utilizes sharding is Spectre [7].

There also exists cryptocurrencies that has taken the decentralization one step further, e.g. IOTA [8]. Here, a Directed Acyclic Graph (DAG) is used where every block is represented by only one transaction and every transaction references and validates at least two other transactions. IOTA is designed to be fully distributed where a user or machine itself needs to compute the hash that validates two other transactions. The disadvantage of IOTA is that it is based on a weak proof of work model. This allows devices with a relatively weak processing power such as mobile phones to compute the hashes. However, this also enables a malicious user with a lot of hashpower to overrun the network. To prevent this they currently have a centralized node, the coordinator, to overview such attacks but there is a high risk that they will never be able to remove this coordinator [15].

An alternative cryptocurrency that also uses a DAG is Raiblocks [9], which has similarities to IOTA but instead utilizes proof of stake validation. However, since the validators has nothing at stake except that the networks validity should remain trusted, there are weak incentives to run nodes except for some central authorities that own most of the coins in the network. In addition, since the network consensus is based on time, it's susceptible to forks from Denial Of Service attacks.

Another DAG solution that is less prone to DoS attacks is Hedera Hashgraph [19, 20, 26]. They have solved the asynchronous consensus problem by calculating a probabilistic time for every transaction over the whole network. They have implemented a highly efficient random gossiping of new information to other peers that allow them to achieve new records of almost 500.000 transactions per second. However, since the gossiping is randomly propagating through the network, the confirmation time does not scale well with increased number of nodes and increased geographical distribution of nodes [20].

### SUMMARY OF THE INVENTION

The present invention takes the Direct Acyclic Graph concept further, presenting a novel asynchronous distributed ledger with validator blocks, where the drawbacks of existing cryptocurrencies has been eliminated, creating a low power consuming and low volatile cryptocurrency with fast transaction speeds. This is done by using a Direct Acyclic Graph for monitoring the state of the system. All validations in the system can be performed in parallel allowing sub-second global confirmation times together with a high number of transactions per second. The consensus can be formed asynchronously and all data generated is directly sent to all other peers reducing the confirmation times to less than the around the globe ping times. The parallelisation enables low confirmation times with low additional overhead when the number of nodes scale up, creating an efficient system without the need of sharding. This technology can be used both in private permission based systems but also in public systems with for example a currency stake consensus model. Transactions are confirmed by validators in a combination of PoS and DPoS consensus making everyone contributing to the consensus of the system and to have something at stake.

In addition a novel decentralized exchange for both crypto and digital fiat is presented. The decentralized exchange can with efficient monetary policies host a stable cryptocurrency based on the average prices of all other currencies that are traded in the system. This exchange and stable cryptocurrency can also be used on already existing distributed ledger systems. The inner currency of the system consist of an asset basket of other currencies and assets that is traded on the decentralized exchange of the system. This effectively creates the most stable currency in the world since it's an average of all other currencies.

By combining the novel distributed ledger with the novel decentralized exchange and its monetary policies, a fully decentralized cryptocurrency can be made eliminating the drawbacks of existing cryptocurrencies and creating an environmentally friendly and less volatile currency with fast transaction speeds. The combination of all these features creates a cryptocurrency that can challenge all other currencies with regards to security, decentralization, speed, cost and environmental benefit.

The technology disclosed relates to a method for achieving consensus in a distributed system by use of vote dependencies.

In one aspect of the invention, technology disclosed relates to a method where a vote dependency is formed by a voting event referencing another voting event also votes on all the events the referenced voting event references, e.g. automatically votes on all the events the referenced voting event references. In one aspect of the invention, the method may include that a node is sending new data to a plurality of nodes connected to the same system/model, e.g. a node may be configured to send new data to all nodes of the distributed network at once, thereby improving speed.

The technology disclosed relates to a system and network configured to achieve consensus in a distributed system by use of vote dependencies.

In one aspect of the invention, the technology disclosed relates to a system and network configured to achieve consensus in a distributed system where the system is configured to form a vote dependency by introducing a model where a voting event referencing another voting event also votes on all the events the referenced voting event references, e.g. automatically votes on all the events the referenced voting event references. In one aspect of the invention, the system and network may be configured so that a node is configured to send new data to a plurality of nodes connected to the same system/network/model, e.g. a node may be configured to send new data to all nodes of the distributed network at once, thereby improving speed.

In different embodiments, the technology disclosed provides a system and related methods for improved transaction speeds, lower volatility and/or low power consumption.

According to methods and system of the technology disclosed, all validators may operate asynchronously on the information they currently have and can make a bet on the part of the transactions and bets they know at a given time. All validators may then calculate how many validators have referenced a certain bet and transaction.

In one aspect of the invention, the technology disclosed provides a system and related methods where more than half of the total bet capital in the system has validated a bet, that bet is considered valid in the system. A transaction may be validated when the sum of total confirmed bets on the transaction has surpassed a certain pre-defined percentage of the total bet capital, e.g. half of the total bet capital.

According to embodiments of the technology disclosed, a consensus is final when the bets approving the transaction has been approved by a majority of the system. In one aspect of the invention, the ordering of the transactions and bets may be done by the highest amounts of bets that has been accumulated at the lowest bet ordering and thereafter, for example, bet size, transaction fee size, timestamp and signature.

In one aspect of the invention, the technology disclosed relates to a method for achieving global consensus with the speed of the internet traffic traveling around ⅔ of the globe. The method may then comprise at least a plurality of the following steps:

1. sending a transaction (Tx) to validator A and B at roughly the same time.

2. receiving the transaction at validator A and B;

3. betting, by said validators A and B, on the transaction (Tx);

4. receiving, by each of validator A and B, the other validator's bet; and

5. achieving consensus.

In one aspect of the invention, the above method further comprises holding, by the system, the state of every account or the accounts/transactions ledger to also contain the states of the accounts, e.g. the balances, where the state of every account may be distributed. In one aspect of the invention, the account ledger may be designed so that every transaction is a unit on the ledger. Furthermore, the transactions may be referenced in such a way that they form a directed acyclic graph (DAG).

In one aspect of the invention, account balances may be calculated by observing the last transaction balance together with all validated transactions that have referenced this account and has so far not been confirmed with a new outgoing transaction, i.e. unconfirmed references. This allows the network to be fully distributed. In one aspect of the invention, only the data of the last validated transaction for an account plus the unconfirmed reference transactions gives the full picture of the account balances on the network.

In one aspect of the invention, the methods according to the technology disclosed differ from prior art solutions in that a node is sending new data to a plurality of nodes connected to the same system/model. In certain embodiments, the methods according to the technology disclosed differ from prior art solutions in that a node is sending new data to all voting nodes at once to thereby improve speed.

In one aspect of the invention, the methods according to the technology disclosed differ from prior art solutions by introducing the action of sending new data to all nodes at once to thereby improve speed.

In one aspect of the invention, the system according to the technology disclosed differ from prior art solutions in that a plurality of nodes in the system are each configured to send new data to a plurality of nodes connected to the same system/model. In one aspect of the invention, the system according to the technology disclosed differ from prior art solutions in that a plurality of nodes in the system are each configured to send new data to all voting nodes connected to the system/model at once to thereby improve speed.

In one aspect of the invention, the methods according to the technology disclosed differ from prior art solutions in that information that needs to be sent is compressed by at least one of:
voting dependency, e.g. a reference to another event implies referencing all the events that event references;
only including partial signatures and a root hash; and
the partial signatures are always included in a specific predefined order.

In one aspect of the invention, the methods according to the technology disclosed differ from prior art solutions by proving sub second finality by summing all vote references after two rounds of voting.

In one aspect of the invention, the methods and system according to the technology disclosed differ from prior art solutions in that the system is configured to determine that a node has rejected or has missed an event by identifying that the node did not reference the event. In certain embodiments, the system is configured to send the event that was rejected or missed by the node to the node.

In one aspect of the invention, the methods and system according to the technology disclosed differ from prior art solutions in providing a stable currency that is an algorithmic trade-balanced basket of other assets.

In one aspect of the invention, the methods and system according to the technology disclosed differ from prior art solutions in that a stable currency linked to an external market currency (USD as example) can be controlled by multiple parties.

In one aspect of the invention, the methods according to the technology disclosed differ from prior art solutions by using a predefined ordering to settle a tie in number of votes.

In one aspect of the invention, the methods and system according to the technology disclosed differ from prior art solutions in that a directed acyclic graph is used.

In one aspect of the invention, the methods and system according to the technology disclosed differ from prior art solutions in that a combination of Proof Of Stake models is used. In different embodiments, the Proof of Stake model may be a delegated model or a non-delegated model.

In one aspect of the invention, the methods and system according to the technology disclosed differ from prior art solutions in that a combination of a Proof Of Stake and a Delegated Proof Of Stake model, which often is referred to a Proof Of Bet. In certain embodiments of the technology disclosed, everyone can become a validator of transactions. To become a validator, a betting amount may typically be locked up as a security deposit in the system. The more stake a validator can lock up, the more voting power it will have.

### BRIEF DESCRIPTION OF THE DRAWINGS

A system and a method according to the present invention will now be described in more detail with reference to the accompanying drawings, where:

FIG. 1 is a schematic of the bets and their order for validators,

FIG. 2 is a schematic of achieving global consensus with the speed of the internet traffic traveling around ⅔ of the globe,

FIG. 3 is a schematic of transactions (T) between accounts,

FIG. 4 is a schematic of the exchange system and how the value of the currency is represented by other currencies, and

FIG. 5 is a schematic and very simplified illustration of buy and sell prices of the inner currency of the system.

### DETAILED DESCRIPTION

In one aspect of the invention, the technology disclosed describes a system for achieving consensus between multiple parties on an event and/or order of events at high speed by verifying and voting on events by creating a voting event referencing one or multiple other events individually or as a group of events and where new data is sent to all nodes at once, thereby improving speed.

In one aspect of the invention, the technology disclosed describes a system for achieving consensus between multiple parties on an event and/or order of events at high speed by verifying and voting on events by creating a voting event referencing multiple other events individually or as a group of events, and where new data is sent to all nodes at once, thereby improving speed.

In one aspect of the invention, the technology disclosed describes a system where the system, or a node of the system, is configured to create a voting event referencing multiple other events individually or as a group of events.

In one aspect of the invention, the technology disclosed describes a system where the system is configured so that a vote dependency is formed by a voting event referencing another voting event also votes on all the events the referenced voting event references. In certain embodiments, a vote dependency is formed by a voting event referencing another voting event also votes on all the events the referenced voting event references and where new data is sent to all nodes at once, thereby improving speed.

In one aspect of the invention, the technology disclosed describes a system configured so that the model used by the system provides so that the order of the voting events are determined by the most number of reference or highest weight voted amount of reference it has collected earliest from the references of other voting events.

In one aspect of the invention, the technology disclosed describes a system configured so that the model used by the system is configured so that a tie in the number of votes is settled by forming a virtual group containing the events with equal votes and where the tie is resolved by a pre decided rules of ordering the events based on the containing data of the events, checksums, fingerprint and/or hashes or similar of the events.

In one aspect of the invention, the technology disclosed describes a system configured so that the model used by the system is configured so that the weight of a vote is determined by methods such as normalized, non-normalized, or capped to thresholds of one vote per party or weighted relative party computing power, stake, bet size or amount of controlled units in a system, and that is either pre decided on, voted on previously or proved to others to have.

In one aspect of the invention, the model used by the system is configured so that finality is proven by reaching at least a majority of available votes on at least two rounds of voting, firstly by ordering of the events and secondly by confirming and proving the order by the second round of voting events.

In one aspect of the invention, the model used by the system is configured so that information of a group of event references is compressed by calculating a fingerprint which is broadcasted to other parties instead of the individual events identification and which other parties can use to determine which events were included in the group.

In one aspect of the invention, the model of the system and the system is configured to simplify knowing which events were in the referenced group of events without blind guessing. In certain embodiments, hints of the containing events in the group are given by sending parts of the individual events identifications as additional data to the groups' identification.

In one aspect of the invention, parallelization in the system may be achieved by sending new events to all other parties in the system directly without relaying these events through other parties in the system.

In one aspect of the invention, the system and the model used by the system is configured so that parties can detect missing, or rejected, events by other parties not referencing them when voting and where the other parties thus can resend or forward those non-referenced events.

In one aspect of the invention, the system and the model used by the system is configured so that referencing is pointing to any identification of another event directly or indirectly through other events or group of events

In one aspect of the invention, the system and the model used by the system is configured so that ordering of events in a group has been pre-decided by the parties of the system based on the individual event's identification.

In one aspect of the invention, the system and the model used by the system is configured so that identification can be any information in the event and/or fingerprint of the event.

In one aspect of the invention, the system and the model used by the system is configured so that the fingerprint used is a mathematical function such as a hash algorithm and/or cryptographic function. In certain embodiments, the ordering of the contained elements in the calculation of the fingerprint may be in any form such a tree, chain, list or proprietary ordering.

In one aspect of the invention, an event can be anything such as an action, transaction, update, bet, vote, block or group of other events.

In one aspect of the invention, the technology disclosed describes a system so that multiple parties have access to two or more separate systems with data storage. In one aspect of the invention, the multiple parties may have access to information that they control jointly, by for example a majority decision. In one aspect of the invention, a majority of the controlling parties agree on making a change on one system and then also make a corresponding change on the other systems, referencing the change with a unique identification verifiable by other parties of the systems.

In one aspect of the invention, the technology disclosed describes a system configured so that a new asset is created and represented by a collection of other assets in the system. The units of the new asset may then be created or destroyed by locking up or releasing respectively the other assets with cryptographical proof showing the ownership of the assets.

In one aspect of the invention, the technology disclosed describes a system configured to automatically balance the locked up assets to reach the target composition by at least one of executing trades, balances volumes and/or prices in such a way to reach a new equilibrium state as fast as possible with low risk.

In one aspect of the invention, the technology disclosed describes a method for achieving consensus between multiple parties on an event and/or order of events at high speed by verifying and voting on events. In one aspect of the invention, the method comprises creating a voting event referencing multiple other events individually or as a group of events. In one aspect of the invention, new data is sent to all nodes at once, thereby improving speed.

In one aspect of the invention, the technology disclosed describes a method for achieving consensus between multiple parties on an event and/or order of events at high speed by verifying and voting on events by creating a voting event referencing multiple other events individually or as a group of events. In one aspect of the invention, new data is sent to all nodes at once, thereby improving speed.

In one aspect of the invention, the technology disclosed describes a method comprising the step of creating a voting event referencing multiple other events individually, or as a group of events.

In one aspect of the invention, the technology disclosed describes a method comprising forming a vote dependency by a voting event referencing another voting event also votes on all the events the referenced voting event references. In one aspect of the invention, the method comprises a vote dependency is formed by a voting event referencing another voting event also votes on all the events the referenced voting event references. In certain embodiments, new data is sent to all nodes at once, thereby improving speed.

In one aspect of the invention, the technology disclosed describes a method that includes the step of determining the order of the voting events by the most number of reference or highest weight voted amount of reference that has been collected earliest from the references of other voting events.

In one aspect of the invention, the technology disclosed describes a method comprising the action of settling a tie in the number of votes by forming a virtual group containing the events with equal votes.

In one aspect of the invention, the technology disclosed describes a method comprising the action of determining the weight of a vote by methods such as normalized, non-normalized, or capped to thresholds of one vote per party or weighted relative party computing power, stake, bet size or amount of controlled units in a system, and that is either pre-decided on, voted on previously or proved to others to have.

In one aspect of the invention, the method comprises that finality is proven by reaching at least a majority of available votes on at least two rounds of voting, e.g. firstly by ordering of the events and secondly by confirming and proving the order by the second round of voting events.

In one aspect of the invention, the method comprises compressing information of a group of event references by calculating a fingerprint. In one aspect of the invention, the method comprises that the fingerprint is broadcasted to other parties (instead of the individual events identification). In certain embodiments, the method comprises that the other parties use the fingerprint to determine which events were included in the group.

In one aspect of the invention, the method according to the technology disclosed includes simplifying knowing which events were in the referenced group of events without blind guessing. In certain embodiments, hints of the containing events in the group are given by sending parts of the individual events identifications as additional data to the groups' identification.

In one aspect of the invention, parallelization in the system may be achieved by the method according to the technology disclosed comprises sending new events to all other parties in the system directly without relaying these events through other parties in the system.

In one aspect of the invention, the method comprises detecting missing, or rejected, events by other parties not referencing them when voting. In certain embodiments, the other parties resend or forward those non-referenced events.

In one aspect of the invention, the method includes pointing to any identification of another event directly or indirectly through other events or group of events

In one aspect of the invention, the method comprises pre-deciding, by the parties of the system, the ordering of events in a group based on the individual event's identification.

In one aspect of the invention, the method includes that the identification can be any information in the event, checksum of the event and/or fingerprint of the event.

In one aspect of the invention, the system and the model used by the system is configured so that the checksum or fingerprint used is a mathematical function such as a hash algorithm and/or cryptographic function. In certain embodiments, the ordering of the contained elements in the calculation of the checksum or fingerprint may be in any form such a tree, chain, list or proprietary ordering.

In one aspect of the invention, an event can be anything such as an action, transaction, update, bet, vote, block or group of other events.

In one aspect of the invention, the technology disclosed describes a method where multiple parties have access to two or more separate systems with data storage. In one aspect of the invention, the method comprises that multiple parties have access to information that they control jointly, by for example a majority decision. In one aspect of the invention, the method includes that a majority of the controlling parties agree on making a change on one system. In certain embodiments, the majority of the controlling parties make a corresponding change on the other systems, referencing the change with a unique identification verifiable by other parties of the systems.

In one aspect of the invention, the technology disclosed describes a method where a new asset is created and represented by a collection of other assets in the system. According to one aspect of the invention, the method comprises that the units of the new asset is created or destroyed by locking up or releasing respectively the other assets with cryptographical proof showing the ownership of the assets. The method may further comprise automatically balancing the locked up assets to reach the target composition by at least one of executing trades, balances volumes and/or prices in such a way to reach a new equilibrium state as fast as possible with low risk.

In one aspect of the invention, a voting event can be a bet, vote, block or similar.

In one aspect of the invention, a bet can be a vote, voting event, block or similar.

In one aspect of the invention, a block can be a vote, voting event, bet or similar.

In one aspect of the invention, a vote can be a voting event, block, bet or similar.

### Technical Specification of the Distributed Ledger

### Consensus Model

The consensus model of the system can be a combination of a Proof Of Stake and a Delegated Proof Of Stake model, called Proof Of Bet. Everyone can become a validator of transactions. To become a validator, a betting amount is locked up as a security deposit in the system. The more stake a validator can lock up, the more voting power it will have.

The system reaches consensus when more than half of the locked up capital has approved an action in the system. Since it is inefficient to have a small stake and run a validator node, users with small and medium size capital can delegate their betting stake to other validators. This makes the system more efficient and allows more users to contribute to the consensus.

To prevent the nothing at stake problem, validators can directly be punished by other validators in case it misbehaves, thus losing a part of its stake directly. If a delegator chooses a misbehaving validator, the delegator will be punished as well. To force the validator to take the largest hit when misbehaving, the validators need to stake more than a certain percentage of the delegated stake, i.e. the effective voting power of the validator is the minimum of its own stake and a percentage of the delegated capital. This allows both the delegator and the validator to have something at stake and efficiently eliminating the nothing at stake problem and forces everyone to make correct decisions on who should control the network.

This proposed consensus model effectively takes the best from both the DPoS and PoS systems and eliminates the drawbacks the two consensus algorithms have on their own.

### Consensus Ledger Design

The system consists of a Directed Acyclic Graph (DAG), where bets references other bets.

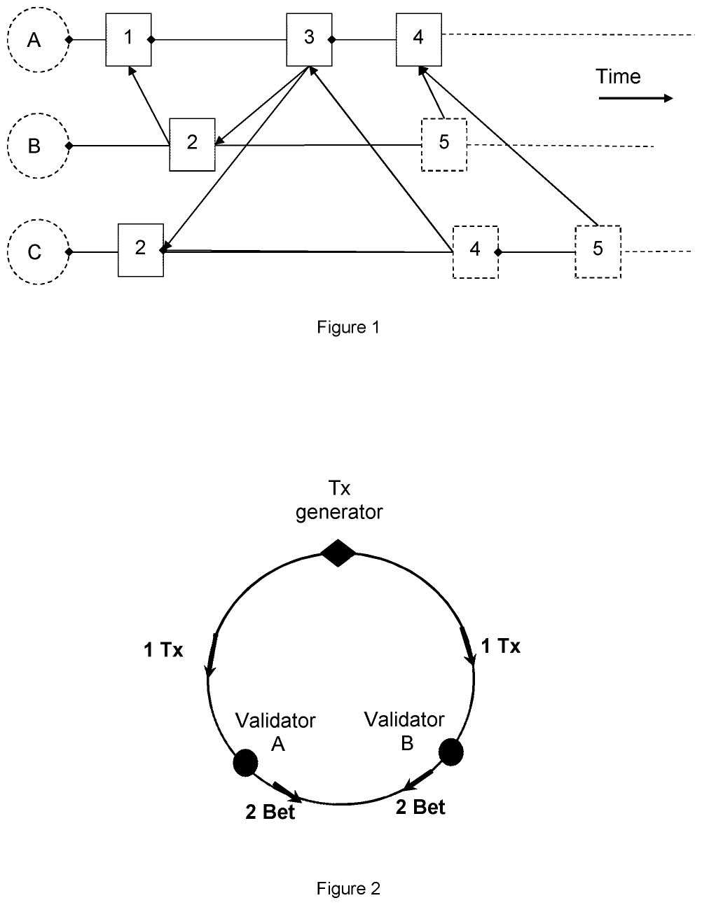

FIG. 1 is a schematic of the ledger with the bets and their order for validators A, B and C. A new bet references that validators last bet and every other bet it has seen, and can validate the bets and transactions that are not referenced indirectly by other bets. A bet in a dashed square is so far an unconfirmed bet.

Every bet can be viewed as a block and contains a compressed reference list of all transactions it validates, all bets it validates and the state of all accounts. The state of all accounts can be omitted if a distributed account ledger is used instead. A block can also contain a sequence number for that validator and personal signature as defined below:

Example of content of a bet:

Generator Id

Generators Sequence Number

Timestamp

Bet order number: Highest referenced+1

List of transaction references

List of bet references

Accounts state

Signature

As opposed to a blockchain, all validators can operate asynchronously on the information they currently have and can make a bet on the part of the transactions and bets they know at a given time. All validators can then calculate how many validators have referenced a certain bet and transaction. When more than half of the total bet capital in the system has validated a bet, that bet is considered valid in the system. A transaction is validated when the sum of total confirmed bets on the transaction has surpassed half of the total bet capital.

The consensus is also final since the bets approving the transaction has been approved by a majority of the system. The ordering of the transactions and bets can be done by the highest amount of bets that has been accumulated at the lowest bet ordering and thereafter for example bet size, transaction fee size, timestamp and signature.

The size of a bet can be efficiently compressed. Firstly, if one bet references another bet, it indirectly validates all transactions and bets in the referenced bet, resulting in transaction and bet signatures that only need to be added once and thereafter be referenced through other bets, allowing one bet to validate thousands of bets and transactions.

Secondly, both the transaction references and bet references can be compressed efficiently to as little as a few bytes and can then be verified by for example a merkle tree root signature. This can be achieved efficiently by two separate parts. One having a predetermined order for the bets and transactions that all validators know about for the generation of the verification signature which reduces the number of possible combinations for generating the correct verification signature for the transactions and bets. The ordering can for example be done by the timestamp and signature of the transaction. Since every validator knows the order, it can make good guesses on how the verification signature was generated. In theory, the compression can go as far as only needing a single merkle tree root for all references and states, but the decreased bandwidth and storage comes at a high cost of CPU calculations when the validators need to guess what the other validators has included in their trees. Therefore compressing the reference signatures to a few bytes, for example by just using the last byte of a full signature and use them as hints will by its own reduce the number of combinations that is needed for generating the verification hashes. By then combining the ordering of transactions with the compression of the signatures will allow the system to process thousands of transactions simultaneously with very low bandwidth overhead and low number of wasted CPU cycles on guessing the correct transaction and bets for generating the verification hash.

Since bets can be made asynchronously the system can achieve very high transaction validations per second and low confirmation times. The lowest possible confirmation time is achieved when a validator sends out a bet to all other validators as soon as it receives a new transaction. If a transaction is sent to all validators at once and all validators bet immediately when it arrives, global consensus can be achieved in less than the around the globe ping time, as shown in FIG. 2.

FIG. 2 is the schematic of achieving global consensus with the speed of the internet traffic traveling around ⅔ of the globe. 1. One transaction (Tx) is sent to validator A and B at roughly the same time. 2. Both validator A and B bets as soon as they receive the transaction. When they have received the other validators bet, consensus is achieved.

However, if everyone bets immediately when the transaction is received a lot of data is generated since the header of every bet is relatively large and the indirect reference compression is not used. Practically a combination of latency and throughput can therefore be chosen depending on the need of the application. Total throughput as determined by number of transaction per second the system can confirm is correlated to the latency defined as the average confirmation times for the transactions. For example, the bet interval for every validator can be set in such a way that the global average confirmation time always is less than a second.

In summary an asynchronous betting strategy, with efficient compression and delivery directly to all validators reaches close to the theoretical limits of a distributed ledger consensus protocol and only the tradeoff between the transactions per second and average confirmation time needs to be decided. This tradeoff can be controlled by how much the validators are paid for running the system.

### Account Ledger Design

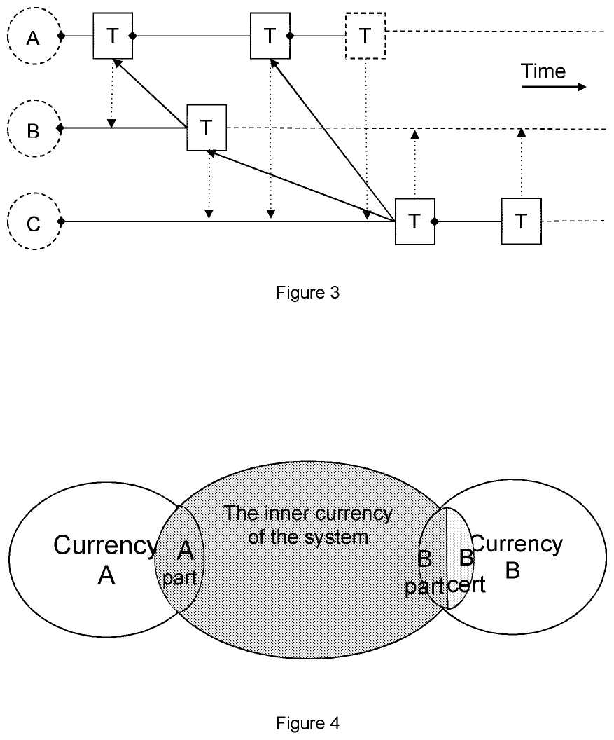

The system can either have the consensus/bet ledger to hold the state of every account or the accounts/transactions ledger to also contain the states of the accounts, e.g. the balances. If the state of every account is distributed, a design like FIG. 3 can be used. The account ledger can be designed so that every transaction is a unit on the ledger. Furthermore the transactions are referenced in such a way that they form a directed acyclic graph (DAG). The last vertex of an account represents the last outgoing transaction of a specific account. When a new transaction is to be performed, it is published on the network referencing the last outgoing transaction performed on the account, all validated incoming transactions that so far has not been confirmed as received, and its new state, e.g. the balance.

FIG. 3 illustrates Transactions (T) between accounts A, B and C. A new transaction references its last transaction (line starting with a square), which account to transfer funds to (dashed arrow) and every validated transaction that has been referred to this account (solid arrow). A transaction in a dashed square is a so far unconfirmed transaction on the network.

Account balances can be calculated by observing the last transaction balance together with all validated transactions that have referenced this account and has so far not been confirmed with a new outgoing transaction, i.e. unconfirmed references. This allows the network to be fully distributed where only the data of the last validated transaction for an account plus the unconfirmed reference transactions gives the full picture of the account balances on the network.

Reward Policy

When a new transaction is published to the network by an account holder, a fee for processing the transaction is attached to give incentives for validators to confirm the transaction. A validator can either bet on a transaction being valid or ignore it. The reward if correct is proportional to the size of the bet and how fast the bet was made relative to other validators, i.e. the ones taking the highest risks and cost of making bets often gains the largest part of the reward:

reward∝size of bet*how early the bet was performed relative to others

The order of the betting is determined by the order a validator validates previous bets, relative to being validated itself as shown in FIG. 1. When the bets approving the transaction is more than half of the total betting capital, the transaction is approved by the system.

To optimize the reward function every validator can in addition add a transaction fee to each of their bets to promote other validators to bet on their bet. In this way the market powers will affect the network to self organize in the most optimal speed and cost efficient way.

Sine the reward promotes speed in the network, the fastest way to propagate a bet is to send it directly to all other validators. Contrarily, the more a bet references other bets the higher rewards relative to the cost of publishing the bet can be gained. These factors together push the transactions fees in the network downwards for efficiency and if users want lower confirmation times they need to pay higher fees.

### Double Spends

A double spend is when a user tries to spend the same money twice. A double spend attack on the network can occur when a user tries to send two or more transactions with the same transaction sequence number or previous reference number to the network. Double spends can be handled in two different ways by the network. One solution is that double spend transactions are ignored by the network as soon as they are detected. Validators might vote on one transaction and it might turn valid but two transactions can never both achieve more than a majority of the votes. This has the effect that malfunctioning accounts might never be recovered.

Alternatively the validators can try to reach consensus on which of the transactions that should be valid. Validators will initially receive one of the transactions before the other and see that one as valid and it is also possible that a bet will be made on it before it knows of the double spend. When it knows about the double spend it needs to decide on which of the transactions are valid. It can do this by ordering the double spend transactions it has, for example by how much the transaction has been approved by the system, the highest transaction fee, the lowest timestamp and the signature. In that way there is always one transaction that is seen as valid and the rest are invalid. When the system has approved a majority of the bets that approve the transactions, the system will know which the correct transaction was.

If a validator accidently bet on one of the transactions that will not be the final valid transaction, it will not receive any rewards for that transaction. Other validators will also ignore betting on the validators bet that includes this faulty transaction, making it likely to lose rewards for other transactions in its bet. When the validator has detected the double spend in the network and has made a bet on the correct transaction, other validators will start validating its bets again.

If a validator is double betting, i.e. sending different information to different parts of the system, it will immediately be ignored by the rest of the system since it can pose a risk and cost for other validators. That validator and its delegators can consequently be punished by losing a part of their stake.

### Technical Specification of the Currency

### Monetary Exchange

On a distributed ledger system a decentralized monetary exchange can exist. The decentralized exchange can handle both crypto and digital fiat money. To achieve high liquidity all currencies can be traded through the internal currency of the system, i.e. making that currency an autonomous decentralized market maker. At the same time these trades gives the internal currency of the system a value, the amount it currently owns in other currencies, i.e. making it a decentralized currency basket.

The network holds its assets on other chains in multi signature wallets that can only be used if a majority of the largest trusted validators sign the transactions together. To achieve high exchange speeds for the currency exchange, other currencies can be bond in two ways to the network, as illustrated in FIG. 4. In the example of currency A, the exchange can be made off chain assuming the currency can handle off chain transactions, e.g. lightning network [22] or the technology of this system. If the currency can't handle fast off-chain transactions like currency B, the currency is first deposited to an account which the validators of this network owns. When the transfer has been confirmed by network B, a certificate for the currency or asset is issued on this system's network. This asset can be traded with high speed on the network and exchanged back to the real currency or asset on network B when needed.

FIG. 4 shows a schematic of the exchange system and how the value of the currency is represented by other currencies. Currencies that are fiat backed and using the technology of this system, or networks with off chain transactions such as lightning network [22] can directly be traded (A). In other currency networks (B) the currency is first deposited as a security and a certificate is issued that can be used inside this network.

By issuing currency certificates with a 1:1 exchange ratio, all other currencies can indirectly be exchanged inside this network with the speed that this system has to offer. This functionality efficiently extends the possibilities of micropayments to other currencies as well.

A currency that is using the technology according to this invention, but is a separate private or public network, can for example be a national currency controlled either by a central bank of a nation or companies that join and create their own network of trust for the currency of their choice. For such a currency the market will thereafter decide the exchange rate towards the inner currency of the system. This allows any nation, company or organization to create their own currency with direct trading to other currencies.

### Monetary Policy

The price of a currency relative to another can be linked to the money supply, money demand and money circulation, according to the Quantity Theory of Money [11]. If the money supply is relatively constant or just slowly growing relative to demand, the price can change heavily since it is directly linked to the demand of the currency.

In this system, the money supply is instead dynamic, which results in a much more stable currency since an increase in demand can generate an increase in supply. The supply and demand of the inner currency of the system is directly related to how much the exchange will be used. If a user wants more of the inner currency of the system it can exchange another currency or asset for it. Reversibly if it wants less of the inner currency of the system it can exchange these for the currency it would rather own. The system itself controls how much of a certain currency it wants in its basket by defining buy and sell prices. The goal of the system is always to have a basket that is volume weighted relative to the volume of trades of all other currencies in the exchange. This is to make sure that it can exit positions with low risks and that the markets trade volume controls its real price. The system will always have a spread for its buy and sell prices relative to the risk it takes.

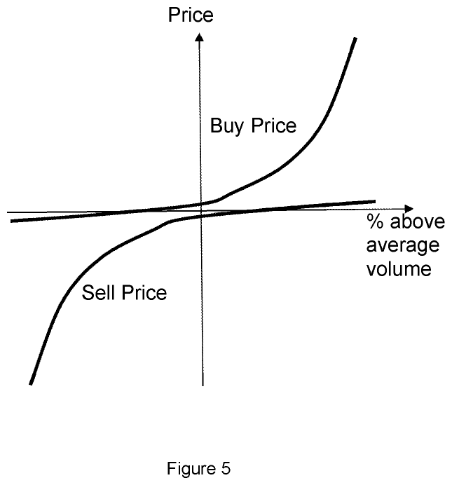

FIG. 5 illustrates the buy and sell prices of the inner currency of the system towards another currency relative to the market price of the exchange rates. If one currency's part of the whole currency basket is higher than the average volume, the buy price will increase to reduce new units being created from that currency, at the same time the sell price is increased to give incentive for reducing that part of the currency in the basket. Oppositely if the currency basket is lacking a certain currency, incentive to add more of that currency into the basket is created by reducing the buy price and decreasing the sell price.

At equilibrium, a small spread exists that represents the gain the exchange makes for each currency exchange. This gain represents the risk the system makes for creating instant currency exchanges. If the volume of a currency trade increases, both the risk of the system and the spread can decrease. If the system makes high profits the value of the inner currency of the system will increase for all owners of the currency. Oppositely, if it loses money on the trades the value of the inner currency will decrease. The profits the system makes will move towards the profits similar to competing systems. Since the cost of running this type of system goes towards zero with time and better technology, the cost of currency exchanges will always go towards zero.

Since the internal currency of the system will be volume weighted relative to all other currency trades, it will directly be the most stable currency in the world since it is an average value of all other currencies, without having a peg to any of them. This make the inner currency of the system a perfect coin for international trade.

In conclusion, this monetary policy together with the rewards system will always try to minimize transaction costs and maximize transaction speeds while giving incentives towards keeping the currency stable relative to trade balances in the outside world, i.e. the minimal cost of running a completely decentralized monetary system will be targeted.

### Risks and Countermeasures of the System

Risks of the protocol include double spend attacks, double betting and trading of bad assets.

### Transaction Attacks

Spamming invalid transactions to a node can be done in many different ways. Every node has an incentive to prevent malicious requests as much as possible to reduce its wasted resources for processing invalid transactions. If unusual behaviour is detected every node will try its best to prevent invalid traffic.

Another spamming attempt is for valid transactions to be sent to the network. First of all, for the network to validate a transaction it must have a processing cost. Since the transaction fee is always close to the real cost of processing the transaction in the network, there will be no gain for an attacker to do this kind of attack. There can be an effect on the network becoming slower, but that would only increase the average transaction fees in the network and automatically distribute the increased load.

The most costly and tricky attacks are double spend attacks. However, from the validators perspective, they will always want to maximize their gain/risk ratio. This will imply that validators will always be on the lookout for suspicious behaviour in the system and demand higher transaction fees and lower transaction confirmation speeds the higher risk the transaction has. Betting optimization will therefore always be beneficial for validators in the system and will likely give incentives to develop machine learning algorithms for fraud prevention.

An alternate attack can be sending transactions to a subset of validators. This can slow down the network until everyone has the information about the transactions and can validate them. Validators will take countermeasures by increasing fees for suspicious accounts and also block the servers that doesn't deliver correctly. A final measure by the validators is to skip information not everyone has access to and only validate the subset everyone has access to.

### Currency Stability Risks

One risk of the protocol is if the value of the currencies in the basket drops significantly. In this case, the value of the inner currency of the system will also drop. To reduce the risk of currency instability, the system can take a few different measures. It can trade in such a way that no asset will have too large part in the basket, and it will keep its ownership to a part of the daily turnover of each asset, to enable a smooth exit from the market. If the system is greedy and try to earn money on the trades it will increase its risks since currency exchange will move away from the system to cheaper alternatives. Contrarily, if the profits are low the system will be used for more trades and the risks will be reduced. In the long run the profits will always reach the market cost of currency exchange, and since this system pushes cost for exchange downwards towards zero it will compete with the transaction cost on alternative markets and simultaneously push them downwards. However, the system itself also has an additional benefit towards other traders in the system. Since all trades goes through the inner currency of the system it will be able to get its trades closed before external traders, efficiently protecting it from sudden market changes.

### Betting Risks

Betting wars or betting exclusion are other potential risks of the system. Since there is an incentive to be first in confirming bets for a transaction, separate chains of bet transactions can win/lose. There is always an incentive to being the first better and exclude other betters from the bettings chains. Cartels can thus form and exclude other validators bets. For example, better A can always reference B, but B avoids referencing A. This then gives no incentive of A referencing B. This can be solved by attaching forwarding of fees on a bet, giving incentives to others to make a bet on a specific bet—efficiently adding a market economy to the validations.

Double betting is also a possible risk that validators will have to watch out for. However, since the validators always validate bets at the same time they validate transactions, cheating betters will be punished fast and excluded from gaining any payouts for rewards and thus lose their locked up bet stake.

### Extensions and Improvements

The system can be further improved by having dedicated servers with the sole responsibility of offloading the validators traffic. For example the sending of transactions to all validators can be a dedicated role that offloads the validators. These specialized servers can receive a part of the transaction fees.

Even though the additional bandwidth overhead for an additional validator is low in the network, the number of connections open will increase by one for every additional validator since all data is sent directly to all other validators. To release the strain on the number of connections open, validators with close geographical location can collaborate by sending each other data or outsourcing the sending of their bets to specialized servers only routing the data. In this way the speed of the network can almost be retained but the number of validators in the network can grow past possible open socket limitations.

Another possible improvement is to use UDP instead of TCP for reducing the need of open socket connections. However, lost data can reduce the speed of the system but if a validator is not betting on what a node has sent, the data is likely lost and it will know that it should be recent.

The protocol can also host other things other than the transfer of money. Smart contracts and escrow payments can for example be added to the transaction chain.

It will be understood that that the invention is not restricted to the aforedescribed and illustrated exemplifying aspects and embodiments thereof and that modifications can be made within the scope of the invention as defined by the accompanying Claims.

### REFERENCES

1. Bitcoin: A Peer-to-Peer Electronic Cash System, Satoshi Nakamoto,
2. Steam is no longer supporting Bitcoin, The Steam Team, Dec. 6, 2017,
3. Average Confirmation Time, blockchain.info, Dec. 16, 2017
4. Bitcoin Is An Asset, Not A Currency, Jeffrey Dorfman, May 17, 2017
5. Bitcoin mining consumes more electricity a year than Ireland, Alex Hern, Nov. 27, 2017
6. Sharding FAQ, Daniel Tsui, Dec. 10, 2017
7. Understanding Serenity, Part 2: Casper, Vitalik Buterin, Dec. 28, 2015,
8. The Tangle Version 1.3, Serguei Popov, Oct. 1, 2017
9. RaiBlocks: A Feeless Distributed Cryptocurrency Network, Colin LeMahieu
10. Basecoin: A Price-Stable Cryptocurrency with an Algorithmic Central Bank (Version 0.99.4), Nader Al-Naji, Josh Chen, Lawrence Diao, Dec. 9, 2017
11. Quantity theory of money, Wikipedia, May 23, 2018
12. Bitcoin Avg. Transaction Fee historical chart, May 23, 2018
13. The Ripple Protocol Consensus Algorithm, David Schwartz, Noah Youngs and Arthur Britto, Ripple Labs Inc, 2014
14. Bitcoin and Ethereum vs Visa and PayPal—Transactions per second, altcointoday.com, Apr. 22, 2017
15. IOTA is centralized, Eric Wall, Jun. 14, 2017
16. Proof of Stake FAQ, Ethereum github, 31 Oct. 2017
17. Basecoin (aka the Basis Protocol): the worst idea in cryptocurrency, reborn, Preston Byrne, Apr. 18, 2018
18. The Dai Stablecoin System, whitepaper, Maker Team, December 2017
19. THE SWIRLDS HASHGRAPH CONSENSUS ALGORITHM: FAIR, FAST, BYZANTINE FAULT TOLERANCE, LEEMON BAIRD May 31, 2016
20. Hedera: A Governing Council & Public Hashgraph Network, Leemon Baird et. al, Mar. 13, 2018
21. Delegated Proof-of-Stake Consensus, Bitshares, May 7, 2018
22. The Bitcoin Lightning Network: Scalable Off-Chain Instant Payments, Joseph Poon and Thaddeus Dryja, Jan. 14, 2016
23. EOS.IO Technical White Paper v2, EOSIO github, Mar. 16, 2018
24. Why Tether's Collapse Would Be Bad for Cryptocurrencies, Sandra Upson, Jan. 30, 2018
25. Consensus system for tracking peer-to-peer digital records, Lance Kasper, U.S. Pat. No. 9,875,510B1, Jan. 23, 2018
26. Methods and apparatus for a distributed database within a network, Leemon C. Baird, U.S. Pat. No. 9,529,923B1, Dec. 27, 2016

1-46. (canceled)

47. A system for achieving consensus between multiple parties, where the system consists of a plurality of computers in a network with a distributed ledger, updated by the system, and where consensus is achieved on an event by voting on an event and/or order of events at high speed by verifying and creating a voting event referencing one or multiple other events individually or as a group of events and where the system is configured so that a vote dependency is formed by a voting event referencing another voting event also votes on all the events the referenced voting event references.

48. The system according to the claim 47, wherein the model used by the system provides that the order of the voting events are determined by the number of reference or highest weight voted amount of reference it has collected earliest from the references of other voting events and where a tie in the number of votes is settled by forming a virtual group containing the events with equal votes and that ordering of events in a group has been pre-decided by the parties of the system based on the individual event's identification and where the model used by the system is configured so that finality is proven by reaching at least a majority of available votes on at least two rounds of voting, firstly by ordering of the events and secondly by confirming and proving the order by the second round of voting events and wherein the model used by the system is configured so that the weight of a vote is determined by methods such as normalized, non-normalized, or capped to thresholds of one vote per party or weighted relative party computing power, stake, bet size or amount of controlled units in a system, and that is either pre decided on, voted on previously or proved to others to have.

49. The system according to claim 48, where the model used by the system is configured so that information of a group of event references is compressed by calculating a new identification which is broadcasted to other parties instead of the individual events identification and which other parties can use to determine which events were included in the group.

50. The system according to claim 49, where the model of the system is configured to simplify knowing which events were in the referenced group of events, without blind guessing, hints of the containing events in the group are given by sending parts of the individual events identifications as additional data to the groups identification.

51. The system according to claim 50, where the system and the model used by the system is configured so that parties can detect missing, or rejected, events by other parties not referencing them when voting and where the other parties thus can resend or forward those non-referenced events.

52. The system according to claim 51, where the system and the model used by the system is configured so that referencing is pointing to any identification of another event directly or indirectly through other events or group of events and where the system and the model used by the system is configured so that identification can be any information in the event and/or fingerprint of the event and where fingerprint used is a mathematical function such as a hash algorithm and/or cryptographic function, and where ordering of the contained elements in the calculation of the fingerprint can be in any form such a tree, chain, list or proprietary ordering.

53. The system according to claim 47, where parallelization in the system can be achieved by sending new events to all other voting parties in the system directly without relaying these events through other parties in the system.

54. The system according to claim 47, where the system and the model used by the system is configured so that multiple parties have access to two or more separate systems with data storage and further has access to information that they control jointly, by for example a majority decision, where a majority of the controlling parties agree on making a change on one system and then also make a corresponding change on the other systems, referencing the change with a unique identification verifiable by other parties of the systems.

55. A method for achieving consensus between multiple parties in a distributed system, comprising of a network consisting of a plurality of computers and a distributed ledger, updated by the system, where consensus is achieved on an event and/or order of events ledger at high speed by verifying and voting on events by the use of vote dependencies by creating a voting event referencing one or multiple other events individually or as a group of events where the voting event also votes on all the events the referenced voting event references, and wherein an event can be anything such as an action, transaction, update, bet, vote, block or group of other events and wherein the referencing comprises pointing to any identification of another event directly or indirectly through other events or group of events and wherein the identification can be any information in the event, and/or fingerprint of the event and where the fingerprint used is a mathematical function such as a hash algorithm and/or cryptographic function, and where ordering of the contained elements in the calculation of the fingerprint can be in any form such a tree, chain, list or proprietary ordering.

56. The method according to claim 55, wherein the method comprises sending new events to all other voting parties in the system directly without relaying these events through other parties in the system thereby improving speed.

57. The method according claim 55, wherein the method further includes the step of determining the order of the voting events by the most number of reference or highest weight voted amount of reference that has been collected earliest from the references of other voting events and wherein the method further comprises the action of settling a tie in the number of votes by forming a virtual group containing the events with equal votes and where the ordering of events in a group is pre-decided by the parties of the system based on the individual event's identification and where finality is proven by reaching at least a majority of available votes on at least two rounds of voting, e.g. firstly by ordering of the events and secondly by confirming and proving the order by the second round of voting events and where the method further comprises the action of determining the weight of a vote by methods such as normalized, non-normalized, or capped to thresholds of one vote per party or weighted relative party computing power, stake, bet size or amount of controlled units in a system, and that is either pre-decided on, voted on previously or proved to others to have.

58. The method according to claim 57, wherein the method comprises compressing information of a group of event references by calculating a new identification and where the method comprises broadcasting the new identification to other parties, instead of the individual events identification and wherein the method comprises that the other parties use the new identification to determine which events were included in the group.

59. The method according to claim 58, wherein the method comprises simplifying knowing which events were in the referenced group of events without blind guessing hints of the containing events in the group is provided by sending parts of the individual events identifications as additional data to the groups' identification.

60. The method according to claim 59, wherein the method comprises detecting missing, or rejected, events by other parties not referencing them when voting and wherein the method comprises resending or forwarding, by the other parties, those non-referenced events.

61. A method to connect two or more different ledger systems and achieve consensus on transactions between these system, wherein multiple parties have access to these two or more separate systems with data storage and further has access to information that they control jointly, by for example a majority decision, where a majority of the controlling parties agree on making a change on one system and then also make a corresponding change on the other systems, referencing the change with a unique identification verifiable by other parties of the systems.

62. The method according to claim 61, wherein the method wherein a new asset is created and represented by a collection of other assets in a system and where units of the new asset can be created or destroyed by locking up or releasing respectively the other assets with cryptographical proof showing the ownership of the assets and where the new asset automatically balances the locked up assets to reach the target composition by at least one of executing trades, balances volumes and/or prices in such a way to reach a new equilibrium state as fast as possible with low risk.
